(19) United States
(12) Patent Application Publication
(10) Pub. No.: US 2026/0147510 A1
(43) Pub. Date: May 28, 2026

(54) MEMORY SUB-SYSTEM WITH CONFIGURABLE REDUNDANT STORAGE

(71) Applicant: Micron Technology, Inc., Boise, ID (US)

(72) Inventors: Vincenzo Reina, München (DE); Marco Redaelli, München (DE)

(21) Appl. No.: 19/388,523

(22) Filed: Nov. 13, 2025

Related U.S. Application Data
(60) Provisional application No. 63/725,984, filed on Nov. 27, 2024.

(51) Int. Cl. G06F 3/06

(52) U.S. Cl. CPC G06F 3/0689; G06F 3/0604; G06F 3/0655

(57) ABSTRACT

This disclosure is directed to a system for configuring a Redundant Array of Independent Disk (RAID) scheme for a memory sub-system. The system accesses Redundant Array of Independent Disk (RAID) configuration information and selects a RAID scheme from a plurality of RAID schemes based on the RAID configuration information. The system receives, from a host system, a request to write a set of data and writes the set of data to a plurality of memory dies of a single stand-alone memory device according to the selected RAID scheme.

### PRIORITY APPLICATION

This application claims the benefit of priority to U.S. Provisional Application Ser. No. 63/725,984, filed Nov. 27, 2024, which is incorporated herein by reference in its entirety.

### TECHNICAL FIELD

Examples of the disclosure relate generally to fault-tolerant memory sub-systems.

### BACKGROUND

A memory sub-system can include one or more memory devices that store data. The memory devices can be, for example, non-volatile memory devices and volatile memory devices. In general, a host system can use a memory sub-system to store data at the memory devices and to retrieve data from the memory devices.

### BRIEF DESCRIPTION OF THE DRAWINGS

The disclosure will be understood more fully from the detailed description given below and from the accompanying drawings of various examples of the disclosure. The drawings, however, should not be taken to limit the disclosure to the specific examples, but are for explanation and understanding only.

FIG. 1 is a block diagram illustrating an example computing system that includes a memory sub-system, in accordance with some examples.

FIG. 2 is a block diagram of a RAID (Redundant Array of Independent Disks) component, in accordance with some examples.

FIG. 3 illustrates an example memory sub-system, in accordance with some examples.

FIG. 4 illustrates a diagram of operations performed using the RAID component, in accordance with some examples.

FIG. 5 is a block diagram of an example computer system, according to some examples.

### DETAILED DESCRIPTION

The present disclosure is directed to a system including a solid-state drive (SSD) with multiple non-volatile memory (NVM) dies (referred to as memory dies) and a processing device operatively coupled to the SSD, configured to perform operations that implement configurable RAID schemes at the die level within a single stand-alone (stand-alone) SSD. In an example, the disclosed processing device selects a RAID configuration to be implemented across the multiple NVM dies within the SSD. The processing device can begin writing data to the NVM dies according to the selected RAID scheme, such as striping data across dies for RAID 0 or mirroring data across dies for RAID 1. When writing data, the processing device distributes the data across the NVM dies based on the chosen RAID configuration. For example, in a RAID 0 implementation, data blocks are alternately written to different dies to improve performance through parallel access. In a RAID 1 implementation, identical copies of data are written to multiple dies to provide fault tolerance. The efficiency of reading, accessing, and managing data is increased through this die-level RAID implementation. Rather than requiring multiple separate SSDs to achieve RAID benefits, the disclosed techniques integrate RAID functionality within a single SSD, which improves the efficiency and flexibility of the storage device and reduces cost of implementing RAID schemes on computing systems. This approach allows for customizable balance between performance, capacity utilization, and fault tolerance within a single SSD package.

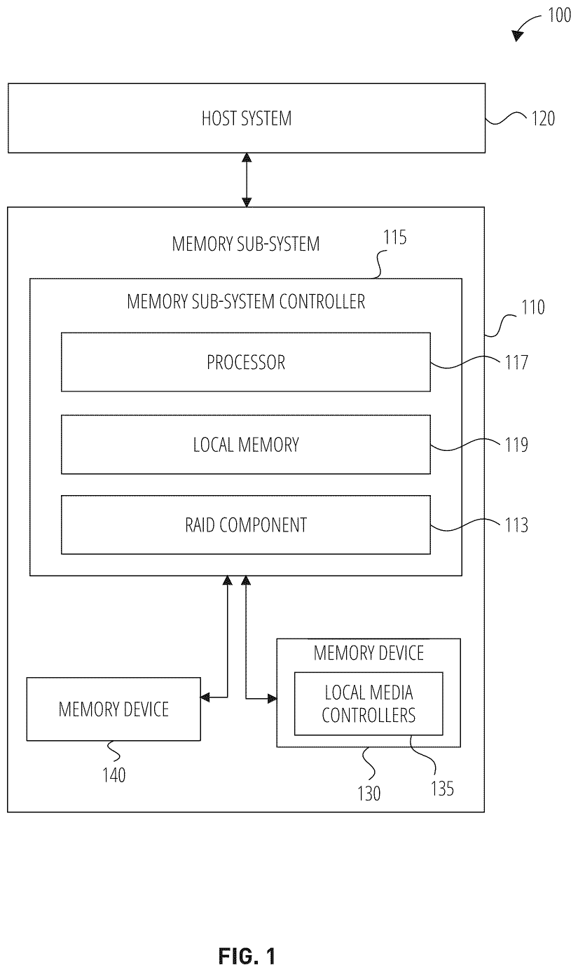

A memory sub-system can be a storage device, a memory module, or a hybrid of a storage device and memory module. Examples of storage devices and memory modules are described below in conjunction with FIG. 1. In general, a host system can use a memory sub-system that includes one or more components, such as memory devices that store data. The host system can send access requests to the memory sub-system, such as to store data at the memory sub-system and to read data from the memory sub-system.

The host system can send access requests (e.g., write command, read command, erase command, and so forth) to the memory sub-system, such as to store data on a memory device at the memory sub-system, read data from the memory device on the memory sub-system, or write/read constructs (e.g., such as submission and completion queues) with respect to a memory device on the memory sub-system. The data to be read or written, as specified by a host request, is hereinafter referred to as “host data” or “user data.”

A host request can include logical address information (e.g., logical block address (LBA), namespace) for the host data, which is the location the host system associates with the host data and a particular zone in which to store or access the host data. The logical address information (e.g., LBA, namespace) can be part of metadata for the host data. Metadata can also include error handling data (e.g., error-correcting code (ECC) code word, parity code), data version (e.g., used to distinguish age of data written), valid bitmap (which LBAs or logical transfer units contain valid data), and so forth.

The memory sub-system can initiate media management operations, such as a write operation, on host data that is stored on a memory device. For example, firmware of the memory sub-system may re-write previously written host data from a location of a memory device to a new location as part of garbage collection (GC) management operations. The data that is re-written, for example as initiated by the firmware, is hereinafter referred to as “GC data.”

Examples of system data include, but are not limited to, system tables (e.g., logical-to-physical memory address mapping table, also referred to herein as a logical-to-physical (L2P) mapping table (referred to as an L2P table), data from logging, scratch pad data, and so forth).

A memory device can be a non-volatile memory device. A non-volatile memory device is a package of one or more die. Each die can be comprised of one or more planes. For some types of non-volatile memory devices (e.g., NAND-type devices), each plane is comprised of a set of physical blocks. For some memory devices, blocks are the smallest area that can be erased. Each block is comprised of a set of pages. Each page is comprised of a set of memory cells, which store bits of data. The memory devices can be raw memory devices (e.g., NAND), which are managed externally, for example, by an external controller. The memory devices can be managed memory devices (e.g., managed NAND), which are a raw memory device combined with a local embedded controller for memory management within the same memory device package. The memory device can be divided into one or more zones where each zone is associated with a different set of host data or user data or application.

In an example, a RAID implementation can use multiple separate SSDs to achieve improved performance, fault tolerance, or a combination of both. These methods, while effective, often come with significant drawbacks in terms of efficiency, resource utilization, and cost. One of the primary inefficiencies of some RAID implementations is the need for multiple complete SSD units. This approach requires each SSD to have its own controller, interface, and packaging, leading to increased hardware costs and power consumption. For example, implementing RAID 1 (mirroring) can include or use two separate SSDs, effectively doubling the hardware requirements and associated expenses.

Furthermore, some RAID setups use additional hardware or software RAID controllers at the host level. This not only adds to the overall system complexity but also introduces potential bottlenecks and points of failure. Such RAID implementations using multiple SSDs or other hard drives not only increase hardware costs and complexity, but also impose bottlenecks on the host interface. This bottleneck arises because all data must be transmitted over the same bus to multiple SSDs, effectively limiting the overall system performance. For instance, in a RAID 0 configuration with two separate SSDs, the host controller splits the data and sends it separately to each SSD over the same interface. This process can create congestion on the data bus, potentially negating some of the performance benefits gained from striping the data across multiple drives. Similarly, in a RAID 1 setup, the host duplicates and sends identical data to multiple SSDs, doubling the amount of traffic on the interface. This bottleneck is particularly pronounced in high-performance applications where large amounts of data need to be transferred quickly. The limitation of the host interface becomes a significant factor, as it can restrict the full potential of the RAID configuration, such as when using high-speed SSDs that are capable of processing data faster than the interface can supply it. Moreover, this inefficiency is exacerbated in scenarios requiring frequent read and write operations, as each operation traverses the same constrained pathway. The result is increased latency and reduced overall system performance, despite the use of multiple high-speed SSDs.

Another inefficiency lies in the inflexibility of some RAID configurations. Once a RAID setup is established using multiple SSDs, changing the RAID level or adjusting the storage configuration often involves complex procedures, sometimes even necessitating data migration. This lack of adaptability can lead to suboptimal resource utilization as storage needs evolve over time. The approach also tends to be wasteful in terms of storage capacity, particularly in scenarios where lower capacities are required. For instance, automotive customers often need storage solutions in lower capacities (64 GB, 128GB) that may not be efficiently supported by new technologies. The trend towards increasing minimum SSD densities due to NAND technology migrations exacerbates this issue, forcing customers to purchase higher-capacity SSDs than they actually need. Lastly, implementing RAID across multiple SSDs can lead to increased physical space requirements and power consumption.

In summary, while some RAID approaches using multiple SSDs can provide performance and reliability benefits, they often do so at the cost of increased hardware requirements, reduced flexibility, inefficient resource utilization, and higher overall system complexity and cost.

The present disclosure addresses these inefficiencies and challenges by implementing RAID at the memory die level, such as within a single stand-alone SSD, offering a more efficient and flexible approach to storage management. These disclosed techniques can include or use multiple memory dies within a single SSD package, allowing for various RAID configurations to be implemented without the need for multiple separate SSDs. By integrating RAID functionality at the die level, the disclosed techniques eliminate the need for additional hardware or separate SSDs, reducing overall system complexity and cost. The single SSD controller manages the RAID implementation across the multiple dies, eliminating the bottleneck imposed by the host interface in conventional multi-SSD RAID setups. Furthermore, the disclosed techniques offer user-programmable RAID schemes, providing flexibility in balancing performance, capacity utilization, and fault tolerance within a single SSD. This adaptability allows users to optimize their storage configuration based on specific needs without the complexities associated with traditional RAID setups. In this way, the disclosed techniques address the issue of inefficient capacity utilization, particularly for customers requiring lower storage capacities. By implementing RAID within a single SSD, the disclosed techniques allow for more efficient use of available storage space, even when minimum SSD densities are increasing due to NAND technology advancements.

In some examples, the techniques described herein relate to a system that includes or uses a single stand-alone memory device with multiple memory dies and a processing device connected to the memory device. The processing device performs several operations. The processing device can access RAID configuration information and select a RAID scheme from various RAID schemes based on this information. When the host system requests to write data, the processing device writes the data to the memory dies according to the chosen RAID scheme.

The RAID schemes available can include RAID 0, RAID 1, RAID 5, and/or RAID 10. Each scheme offers different benefits and trade-offs. While the disclosed techniques relate to these four RAID schemes, any other suitable RAID scheme can be implemented and chosen in a similar manner. In a RAID 0 configuration, the processing device divides the data into chunks. The processing device writes the first chunk to one memory die and the second chunk to another, distributing the data across multiple dies. For RAID 1, the processing device creates two copies of the data. The processing device writes one copy to one memory die and the other copy to a second die. When reading data in this configuration, the processing device can read portions of the data from both copies simultaneously, improving read performance.

In RAID 1, the processing device reports only half of the total storage capacity to the host. This is because the data is duplicated across two dies, effectively halving the available space. RAID 5 involves the processing device dividing data into chunks and generating parity data for each chunk. The processing device writes data chunks and parity data across different memory dies. This allows for data recovery if one chunk becomes unreadable. For RAID 10, which requires four memory dies, the processing device divides the data into chunks. The processing device then writes the first chunk to two memory dies and the second chunk to the other two memory dies, combining the benefits of striping and mirroring.

The processing device manages data storage according to the selected RAID scheme without involving the host system. This approach allows for data recovery even if an entire memory die fails. The processing device can receive commands from the host to select a specific RAID scheme, which it then stores as part of the configuration information. This entire system, including the memory device and processing device, can be implemented as a SSD. The memory device may use three-dimensional (3D) NAND technology. The same functionality is also available as software instructions stored on a non-transitory machine-readable storage medium. When executed, these instructions perform the same operations of accessing RAID configuration information, selecting a RAID scheme, and writing data according to the chosen scheme. Lastly, this functionality can be implemented as a method, following the same steps of accessing RAID configuration information, selecting a RAID scheme, and writing data accordingly.

Though various examples are described herein as being implemented with respect to a memory sub-system (e.g., a controller of the memory sub-system), some or all of the portions of an example can be implemented with respect to a host system, such as a software application or an operating system of the host system.

FIG. 1 illustrates an example computing system 100 that includes a memory sub-system 110, in accordance with some examples. The memory sub-system 110 can include media, such as one or more volatile memory devices (e.g., memory device 140), one or more non-volatile memory devices (e.g., memory device 130), or a combination of such.

A memory sub-system 110 can be a storage device, a memory module, or a hybrid of a storage device and memory module. Examples of a storage device include a SSD, a flash drive, a universal serial bus (USB) flash drive, a secure digital (SD) card, an embedded Multi-Media Controller (eMMC) drive, a Universal Flash Storage (UFS) drive, and a hard disk drive (HDD). Examples of memory modules include a dual in-line memory module (DIMM), a small outline DIMM (SO-DIMM), and various types of non-volatile dual in-line memory module (NVDIMM).

The computing system 100 can be a computing device such as a desktop computer, laptop computer, network server, mobile device, a vehicle (e.g., airplane, drone, train, automobile, or other conveyance), Internet of Things (IoT) enabled device, embedded computer (e.g., one included in a vehicle, industrial equipment, or a networked commercial device), or such computing device that includes memory and a processing device.

The computing system 100 can include a host system 120 that is coupled to one or more memory sub-systems 110. In some examples, the host system 120 is coupled to different types of memory sub-systems 110. FIG. 1 illustrates one example of a host system 120 coupled to one memory sub-system 110. As used herein, “coupled to” or “coupled with” generally refers to a connection between components, which can be an indirect communicative connection or direct communicative connection (e.g., without intervening components), whether wired or wireless, including connections such as electrical, optical, magnetic, and the like.

The host system 120 can include a processor chipset and a software stack executed by the processor chipset. The processor chipset can include one or more cores, one or more caches, a memory controller (e.g., NVDIMM controller), and a storage protocol controller (e.g., a peripheral component interconnect express (PCIe) controller, serial advanced technology attachment (SATA) controller). The host system 120 uses the memory sub-system 110, for example, to write data to the memory sub-system 110 and read data from the memory sub-system 110.

The host system 120 can include or be coupled to the memory sub-system 110 so that the host system 120 can read data from or write data to the memory sub-system 110. The host system 120 can be coupled to the memory sub-system 110 via a physical host interface. Examples of a physical host interface include, but are not limited to, a SATA interface, a peripheral component interconnect express (PCIe) interface, a compute express link (CXL) interface, a USB interface, a Fibre Channel interface, a Serial Attached SCSI (SAS) interface, etc. The physical host interface can be used to transmit data between the host system 120 and the memory sub-system 110. The host system 120 can use an NVM Express (NVMe) interface to access the memory devices 130, 140 when the memory sub-system 110 is coupled with the host system 120 by the PCIe or CXL interface. The physical host interface can provide an interface for passing control, address, data, and other signals between the memory sub-system 110 and the host system 120.

The memory devices 130, 140 can include any combination of the different types of non-volatile memory devices and/or volatile memory devices. The volatile memory devices (e.g., memory device 140) can be, but are not limited to, random access memory (RAM), such as dynamic random access memory (DRAM) and synchronous dynamic random access memory (SDRAM).

Some examples of non-volatile memory devices (e.g., memory device 130) include a NAND type flash memory and write-in-place memory, such as a 3D cross-point memory device, which is a cross-point array of non-volatile memory cells. A cross-point array of non-volatile memory can perform bit storage based on a change of bulk resistance, in conjunction with a stackable cross-gridded data access array. Additionally, in contrast to many flash-based memories, cross-point non-volatile memory can perform a write in-place operation, where a non-volatile memory cell can be programmed without the non-volatile memory cell being previously erased. NAND type flash memory includes, for example, two-dimensional (2D) NAND and 3D NAND.

Each of the memory devices 130, 140 can include one or more arrays of memory cells. One type of memory cell, for example, single level cells (SLCs), can store one bit per cell. Other types of memory cells, such as multi-level cells (MLCs), tri-level cells (TLCs), quad-level cells (QLCs), and penta-level cells (PLCs), can store multiple bits per cell. In some examples, each of the memory devices 130, 140 can include one or more arrays of memory cells such as SLCs, MLCs, TLCs, QLCs, or any combination of such. In some examples, a particular memory device can include an SLC portion, an MLC portion, a TLC portion, or a QLC portion of memory cells. The memory cells of the memory devices 130, 140 can be grouped as pages that can refer to a logical unit of the memory device used to store data. With some types of memory (e.g., NAND), pages can be grouped to form blocks or BSs. As used herein, a block comprising SLCs can be referred to as a SLC block, a block comprising MLCs can be referred to as a MLC block, a block comprising TLCs can be referred to as a TLC block, and a block comprising QLCs can be referred to as a QLC block.

Although non-volatile memory components such as NAND type flash memory (e.g., 2D NAND, 3D NAND) and 3D cross-point array of non-volatile memory cells are described, the memory device 130 can be based on any other type of non-volatile memory, such as read-only memory (ROM), phase change memory (PCM), self-selecting memory, other chalcogenide-based memories, ferroelectric transistor random-access memory (FeTRAM), ferroelectric random access memory (FeRAM), magneto random access memory (MRAM), Spin Transfer Torque (STT)-MRAM, conductive bridging RAM (CBRAM), resistive random access memory (RRAM), oxide-based RRAM (OxRAM), negative-or (NOR) flash memory, and electrically erasable programmable read-only memory (EEPROM).

A memory sub-system controller 115 (or controller 115 for simplicity) can communicate with the memory devices 130, 140 to perform operations such as reading data, writing data, or erasing data (e.g., performing GC operations) at the memory devices 130, 140 and other such operations. The memory sub-system controller 115 can include hardware such as one or more integrated circuits and/or discrete components, a buffer memory, or a combination thereof. The hardware can include digital circuitry with dedicated (e.g., hard-coded) logic to perform the operations described herein. The memory sub-system controller 115 can be a microcontroller, special purpose logic circuitry (e.g., a field programmable gate array (FPGA), an application specific integrated circuit (ASIC), and so forth), or other suitable processor.

The memory sub-system controller 115 can include a processor (processing device) 117 configured to execute instructions stored in local memory 119. In the illustrated example, the local memory 119 of the memory sub-system controller 115 includes an embedded memory configured to store instructions for performing various processes, operations, logic flows, and routines that control operation of the memory sub-system 110, including handling communications between the memory sub-system 110 and the host system 120.

In some examples, the local memory 119 can include memory registers storing memory pointers, fetched data, and so forth. The local memory 119 can also include ROM for storing micro-code. While the example memory sub-system 110 in FIG. 1 has been illustrated as including the memory sub-system controller 115, in another example, a memory sub-system 110 does not include a memory sub-system controller 115, and can instead rely upon external control (e.g., provided by an external host, or by a processor or controller separate from the memory sub-system).

In general, the memory sub-system controller 115 can receive commands or operations from the host system 120 and can convert the commands or operations into instructions or appropriate commands to achieve the desired access to the memory device 130 and/or the memory device 140. The memory sub-system controller 115 can be responsible for other operations such as wear leveling operations, GC operations, error detection and ECC operations, encryption operations, caching operations, and address translations between a logical address (e.g., LBA, namespace) and a physical memory address (e.g., physical block address in a physical address space of the memory device 130 or memory device 140) that are associated with the memory devices 130, 140. The memory sub-system controller 115 can further include host interface circuitry to communicate with the host system 120 via the physical host interface. The host interface circuitry can convert the commands received from the host system 120 into command instructions to access the memory device 130 and/or the memory device 140 as well as convert responses associated with the memory device 130 and/or the memory device 140 into information for the host system 120.

The memory sub-system 110 can also include additional circuitry or components that are not illustrated. In some examples, the memory sub-system 110 can include a cache or buffer (e.g., DRAM) and address circuitry (e.g., a row decoder and a column decoder) that can receive an address from the memory sub-system controller 115 and decode the address to access the memory devices 130, 140.

In some examples, the memory device 130 includes local media controllers 135 that operate in conjunction with memory sub-system controller 115 to execute operations on one or more memory cells of the memory device 130. An external controller (e.g., memory sub-system controller 115) can externally manage the memory device 130 (e.g., perform media management operations on the memory device 130). In some examples, a memory device 130 is a managed memory device, which is a raw memory device combined with a local controller (e.g., local media controller 135) for media management within the same memory device package. An example of a managed memory device is a managed NAND (MNAND) device. Any operation discussed as being performed by the memory sub-system controller 115 can be similarly performed by the local media controllers 135 and vice versa.

The memory sub-system controller 115 includes a RAID component 113. In some cases, the memory sub-system 110 is implemented as a single stand-alone memory system, such as a single stand-alone SSD. In such cases, the memory sub-system 110 can use the RAID component 113 to implement a selected RAID scheme according to configuration information stored in a configuration register, such as the local memory 119.

Specifically, the memory sub-system controller 115 includes a RAID component 113 that enables the memory sub-system controller 115 to efficiently manage data storage and retrieval across multiple memory dies, such as the memory device 130 and memory device 140. The RAID component 113 can be responsible for accessing RAID configuration information, which can be programmed by the user or set by default. Based on this configuration, the RAID component 113 can select an appropriate RAID scheme from various RAID schemes, such as RAID 0, RAID 1, RAID 5, or RAID 10. Each of these RAID schemes offers different trade-offs between performance, capacity utilization, and fault tolerance.

When the host system 120 sends a request to write data, the RAID component 113 manages the distribution of this data across the multiple memory dies according to the selected RAID scheme. For example, in a RAID 0 configuration, the RAID component 113 can stripe the data across different dies (e.g., across the memory device 130 and memory device 140) to improve performance through parallel access. In a RAID 1 setup, the RAID component 113 can create mirrored copies of the data on separate memory dies (e.g., memory device 130 and memory device 140) for enhanced fault tolerance. The RAID component 113 also handles read requests from the host system 120. In configurations like RAID 1, the RAID component 113 can optimize read performance by retrieving data from multiple copies simultaneously or in parallel. This allows for faster data access and improved overall system performance.

In an example, the RAID component 113 can manage all these operations internally within the memory sub-system 110, without requiring the host system 120 to be aware of the specific RAID implementation and its processes. This abstraction simplifies the interaction between the host and the memory sub-system 110, as the host system 120 can treat the memory sub-system 110 as a single, stand-alone, high-performance storage unit. The RAID component 113 can play an important role in data recovery scenarios. In the event of a memory die failure (e.g., if the memory device 140 completely fails), the RAID component 113 can use the redundancy (e.g., stored on a different memory die memory device 130) provided by certain RAID schemes (like RAID 1 or RAID 5) to reconstruct lost data, ensuring data integrity and system reliability.

Additionally, the RAID component 113 can receive commands from the host system 120 to modify the RAID configuration. This allows for dynamic adjustment of the storage characteristics based on changing application needs, providing flexibility that is not typically available in traditional multi-SSD RAID setups. In this way, the RAID component 113 within the memory sub-system controller 115 acts as the central orchestrator for implementing user-programmable RAID schemes within a single memory sub-system 110. The RAID component 113 manages data distribution, retrieval, and recovery across multiple memory dies, while presenting a simplified interface to the host system 120 for data exchange and configuration. Any discussion with respect to the memory device 130 can similarly be applied to the memory device 140.

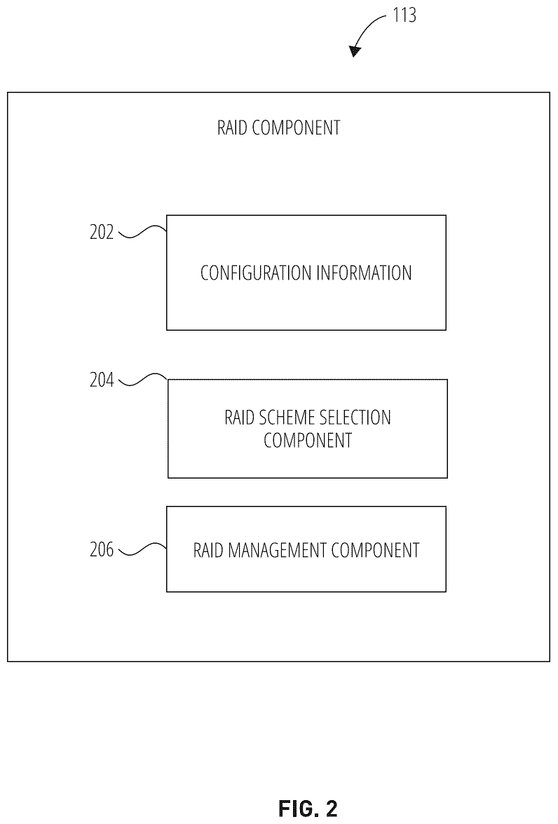

FIG. 2 is a block diagram of a RAID component 113, in accordance with some examples. The RAID component 113 can include configuration information 202 and/or a RAID selection component 204. Specifically, the RAID component 113 includes several subcomponents (e.g., the configuration information 202 and the RAID selection component 204) that work together to improve the operations of the memory sub-system 110.

Specifically, FIG. 2 illustrates the RAID component 113, which can be a part of the memory sub-system controller 115. The RAID component 113 can include or store configuration information 202 (e.g., in the local memory 119). The configuration information 202 can provide or store the RAID configuration data, which can be set by default or programmed by the user. This information determines which RAID scheme will be used for data storage and retrieval across the multiple memory dies within the memory sub-system 110. The configuration information 202 can store a table that associates different bit combinations with different RAID schemes. In such cases, the host system 120 can provide a certain bit combination and, based on that bit combination, the RAID component 113 can search the table stored in the configuration information 202 to select the corresponding RAID scheme. The RAID component 113 can then control and manage storage and retrieval of data according to the selected RAID scheme that has been activated based on the command from the host system 120.

In some cases, the RAID selection component 204 can be responsible for choosing the appropriate RAID scheme based on the configuration information. The RAID selection component 204 can select from various RAID schemes, including RAID 0, RAID 1, RAID 5, and RAID 10, each offering different trade-offs between performance, capacity utilization, and fault tolerance.

For instance, when the host system 120 selects RAID 0 as the RAID scheme, the RAID selection component 204 chooses this RAID scheme and its instructions for implementation based on the configuration information 202. A RAID management component 206 can then divide user data received from the host system 120 into chunks and distribute them across multiple memory dies (e.g., memory device 130 and memory device 140) to improve performance through parallel access. For example, the RAID management component 206 can strip data that is received from the host system 120 across the multiple memory dies. When a read request is received from the host system 120 to retrieve the data, the RAID management component 206 can access the data in parallel from the different memory dies to improve performance.

For RAID 1 implementation, the RAID management component 206 can create two copies of data received from the host system 120. The RAID management component 206 can then write one copy to one memory die (e.g., memory device 130) and another to a second die (e.g., memory device 140). This provides high fault tolerance and allows for improved read performance by reading portions of data from both copies simultaneously. For example, when a read request is received from the host system 120 to retrieve the data, the RAID management component 206 can access the different portions of the same data in parallel from the different memory dies to improve performance.

In the case of RAID 5, the RAID management component 206 can divide the data into chunks and generate parity data for each chunk. The RAID management component 206 can then write the data chunks and parity data across different memory dies, allowing for data recovery if one chunk becomes unreadable. Specifically, RAID management component 206 begins by dividing the incoming set of data into multiple equal-sized chunks. For each set of data chunks, the RAID management component 206 then generates parity data, which is used for data recovery in case of entire memory die failures. The RAID management component 206 writes the data chunks across different memory dies within the memory sub-system 110. This distribution helps in improving read and write performance through parallel access.

Along with the data chunks, the RAID management component 206 also distributes the generated parity data across the memory dies of the memory sub-system 110. The parity data can be written to a different die than the associated data chunks. The RAID management component 206 manages the actual writing of both data chunks and parity data to the appropriate memory dies.

During read operations, the RAID management component 206 retrieves data from the appropriate memory dies. If all dies are functional, it reads the data directly. In case one of the memory dies or data chunks becomes unreadable, the RAID management component 206 uses the parity data and the remaining data chunks to reconstruct the lost information. Namely, when a memory die failure occurs, the RAID management component 206 initiates the reconstruction process by accessing the parity data stored on the other functional dies. This parity information, combined with the data from the remaining operational dies, allows the RAID management component 206 to mathematically reconstruct the lost information from the failed memory die.

The recovery process involves complex calculations where the RAID management component 206 uses the parity data as a reference point to determine what the missing data should be. By comparing the parity data with the available data chunks from the functioning dies, the RAID management component 206 can deduce the content of the lost data chunk or entirely lost data from the entire failed memory die. This approach ensures that even if an entire memory die fails, the RAID component 113 can recover all the data that was stored on that memory die. The redundancy provided by storing parity data on separate dies creates a robust fault-tolerance mechanism, allowing the memory sub-system 110 to maintain data integrity and continue operations even in the face of hardware failures.

The ability to recover data using parity information stored on other dies is an advantage of the RAID 5 implementation within a single memory sub-system 110 (e.g., single stand-alone SSD). It provides a balance between storage efficiency and data protection, allowing the system to recover from single-die failures without the need for complete data duplication as in RAID 1. This recovery process involves complex calculations using the parity data. Lastly, the component manages the effective storage capacity, which in RAID 5 is slightly reduced due to the storage of parity data. For example, if there are N dies, the usable capacity would be (N-1)/N of the total physical capacity. These operations allow the RAID 5 implementation to provide a balance between performance, capacity utilization, and fault tolerance within a single SSD.

For RAID 10 implementation, which may require at least four memory dies, the RAID component 113 divides the data into chunks and writes the same first chunk to two memory dies and the second chunk to the other two memory dies, combining the benefits of striping and mirroring.

The RAID component 113 can manage the storage capacity reported to the host system 120. For example, in RAID 1 configuration, the RAID component 113 reports only half of the total storage capacity to the host system 120, as the data is duplicated across two memory dies. Furthermore, the RAID component 113 enables data recovery in case of memory die failure in an automated approach without any host system 120 involvement. The RAID component 113 can use the redundancy provided by certain RAID schemes to reconstruct lost data, ensuring data integrity and system reliability.

The RAID component 113 also handles commands from the host system 120 to modify the RAID configuration, allowing for dynamic adjustment of storage characteristics based on changing application needs. This flexibility is an advantage over multi-SSD RAID setups. Overall, the RAID component 113 and its subcomponents enable the implementation of user-programmable RAID schemes within a single stand-alone memory sub-system 110, managing data distribution, retrieval, and recovery across multiple memory dies while presenting a simplified interface to the host system for data exchange and configuration.

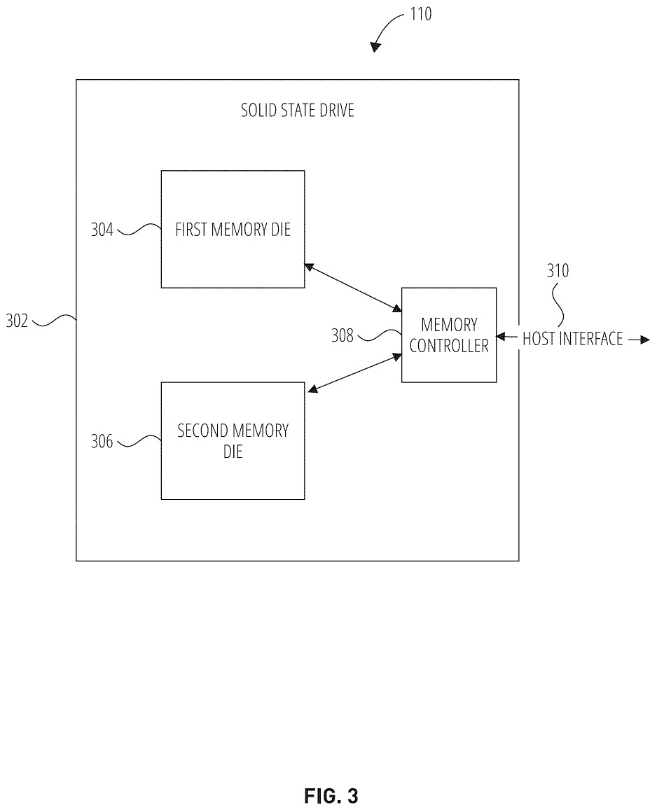

FIG. 3 illustrates an example memory sub-system 110, in accordance with some examples. Specifically, FIG. 3 illustrates an example of a memory sub-system 110, specifically a SSD 302, which integrates multiple components to implement configurable RAID schemes. This configuration enhances data storage and retrieval efficiency, offering improved performance and fault tolerance within a single SSD package.

The SSD 302 can include a first memory die 304 and a second memory die 306. The first memory die 304 and second memory die 306 (which may correspond to memory device 130 and memory device 140) can be non-volatile memory components that store data. The integration of multiple memory dies within a single SSD allows for the implementation of various RAID configurations, such as RAID 0, RAID 1, RAID 5, and RAID 10, as previously discussed.

Memory controller 308 is a component within the SSD 302, responsible for managing data flow between the first memory die 304 and second memory die 306 and the host system 120. The memory controller 308 can execute operations such as reading, writing, and erasing data, and implement RAID configurations to optimize performance and fault tolerance using the corresponding instructions for the selected RAID scheme stored in the configuration information 202. The memory controller 308 accesses the RAID configuration information 202 and selects a RAID scheme based on this information and based on a default setting or command received from the host system 120. The memory controller 308 then writes data to the memory dies (first memory die 304 and second memory die 306) according to the selected RAID scheme.

Host interface 310 provides a communication pathway between the SSD 302 and the host system 120. This interface facilitates the transmission of data and commands, allowing the host system 120 to interact with the SSD 302 efficiently. The host interface 310 supports various protocols to ensure compatibility and high-speed data transfer, enabling the host system 120 to send requests to write or read data from the SSD 302.

In response to determining that a RAID 0 configuration or RAID 0 scheme has been selected by the RAID selection component 204, the memory controller 308 divides user data received from the host system 120 into chunks. The memory controller 308 then writes chunks across the first memory die 304 and second memory die 306 to improve performance through parallel access.

In response to determining that a RAID 1 configuration or RAID 1 scheme has been selected by the RAID selection component 204, the memory controller 308 creates mirrored copies of data received from the host system 120 on both memory dies (first memory die 304 and second memory die 306) for enhanced fault tolerance. For example, if the host system 120 sends a data block “A” to be written, the memory controller 308 can write an identical copy of data block “A” to both the first memory die 304 and the second memory die 306. This mirroring process ensures that there are always two identical copies of the data stored on separate memory dies. If one memory die fails, the data can still be accessed from the other die, providing a high level of data protection.

For instance, if the host system sends data blocks “A,” “B,” and “C” to be written, Data block “A” is written to both the first memory die 304 and the second memory die 306; Data block “B” is written to both the first memory die 304 and the second memory die 306; and Data block “C” is written to both the first memory die 304 and the second memory die 306. This mirroring approach allows for improved read performance as well. When reading data, the memory controller 308 can retrieve different portions of the same data from both copies simultaneously or in parallel, potentially doubling the read speed compared to a non-RAID configuration.

RAID 5 involves generating parity data for data recovery, while RAID 10 combines striping and mirroring for optimal performance and redundancy. To illustrate RAID 5 in the context of FIG. 3, the SSD 302 may have three memory dies instead of two. In such cases, a third memory die in addition to the first memory die 304 and second memory die 306 can be included.

In a RAID 5 configuration, the memory controller 308 can perform the following operations. The memory controller 308 can perform data division. When the host system 120 sends data to be written through the host interface 310, the memory controller 308 divides it into equal-sized chunks. For example, if the host sends data blocks A, B, and C, each can be treated as a separate chunk. The memory controller 308 can generate parity data for each set of data chunks. For example, the parity data for blocks A, B, and C can be referred to as P(ABC). Data and parity can be distributed by the memory controller 308 across the three memory dies in a rotating pattern. For instance, the first memory die 304 can store data block A, the second memory die 306 can store data block B, and the third memory die (not shown) can store parity P(ABC).

The memory controller 308 can manage the actual writing of both data chunks and parity data to the appropriate memory dies using an internal bus (not shown). The memory controller 308 can perform read operations, such as when the host system 120 requests to read data, the memory controller 308 retrieves it from the appropriate memory dies. If all dies are functional, it reads the data directly. In case of data recovery when one of the memory dies fails, the memory controller 308 can reconstruct the lost data using the parity information stored on the other dies. For example, if the first memory die 304 fails, the controller can recover block A by using block B from the second memory die 306 and the parity P(ABC) from the third memory die, performing the necessary calculations to reconstruct the lost data.

This RAID 5 implementation provides a balance between performance, capacity utilization, and fault tolerance. It allows for improved read and write speeds through parallel access to multiple dies, while also providing the ability to recover from a single die failure. The trade-off is a slight reduction in usable capacity due to the storage of parity data. In terms of capacity, if each memory die has a capacity of 256 GB, the total raw capacity would be 768 GB (3×256 GB). However, the usable capacity in RAID 5 would be approximately 512 GB, as one-third of the total capacity is used for parity data. This RAID 5 configuration within a single SSD demonstrates the flexibility and efficiency of implementing RAID at the die level, allowing for enhanced data protection and performance without the need for multiple separate SSDs.

In a RAID 10 configuration, the memory controller 308 can perform the following operations. The memory controller 308 can perform data division. When the host system 120 sends data to be written through the host interface 310, the memory controller 308 divides it into equal-sized chunks. For example, if the host sends data blocks A, B, C, and D, each can be treated as a separate chunk. The memory controller 308 can then distribute and mirror the data chunks across four memory dies in a striped and mirrored pattern. For instance, the first memory die 304 can store data block A, the second memory die 306 can store data block B, a third memory die (not shown) can store a mirror of data block A, and a fourth memory die (not shown) can store a mirror of data block B.

The memory controller 308 can manage the actual writing of data chunks to the appropriate memory dies using an internal bus (not shown). The memory controller 308 can perform read operations, such as when the host system 120 requests to read data, the memory controller 308 retrieves it from the appropriate memory dies. If all dies are functional, it can read the data (or different portions of the data) from either copy, potentially improving read performance.

In case of data recovery when one of the memory dies fails, the memory controller 308 can access the mirrored copy of the data from the corresponding mirrored die. For example, if the first memory die 304 fails, the controller can recover block A by reading it from the third memory die that contains the mirrored copy. This RAID 10 implementation provides a balance between performance and fault tolerance. It allows for improved read and write speeds through parallel access to multiple dies, while also providing the ability to recover from multiple die failures as long as they don't affect both copies of the same data. The trade-off is a significant reduction in usable capacity due to the mirroring of data. In terms of capacity, if each memory die has a capacity of 256 GB, the total raw capacity would be 1024 GB (4×256 GB). However, the usable capacity (reported to the host system 120 by the stand-alone SSD) in RAID 10 would be approximately 512 GB instead of 1024 GB, as half of the total capacity is used for mirroring data. This RAID 10 configuration within a single SSD demonstrates the flexibility and efficiency of implementing RAID at the die level, allowing for enhanced data protection and performance without the need for multiple separate SSDs.

Overall, FIG. 3 demonstrates the integration of multiple memory dies within a single SSD package, managed by a memory controller, to implement RAID functionalities. This configuration allows for improved performance, capacity utilization, and fault tolerance without the need for multiple separate SSDs, as detailed in the examples and claims of the patent draft.

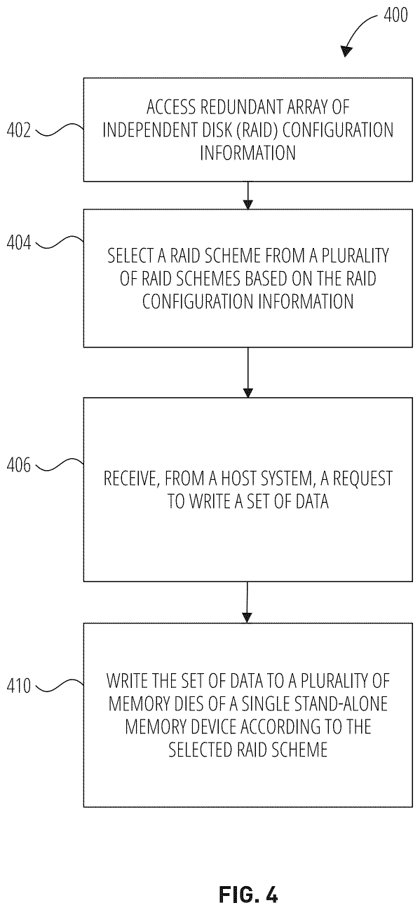

FIG. 4 is a flow diagram of an example routine 400 (method or process) performed using the RAID component 113, in accordance with some examples. The method or process of routine 400 can be performed by processing logic that can include hardware (e.g., a processing device, circuitry, dedicated logic, programmable logic, microcode, hardware of a device, an integrated circuit, and so forth), software (e.g., instructions run or executed on a processing device), or a combination thereof. In some examples, the method or process of routine 400 is performed by the memory sub-system controller 115 or subcomponents of the memory sub-system controller 115 of FIG. 1. In these examples, the method or process of routine 400 can be performed, at least in part, by the RAID component 113. Although the processes are shown in a particular sequence or order, unless otherwise specified, the order of the processes can be modified. Thus, the illustrated examples should be understood only as examples; the illustrated processes can be performed in a different order, and some processes can be performed in parallel. Additionally, one or more processes can be omitted in various examples. Thus, not all processes are required in every example. Other process flows are possible.

Referring now to FIG. 4, the method or process of routine 400 begins at operation 402, with the RAID component 113 of a memory sub-system 110 (e.g., memory device 140) accessing RAID configuration information. Then, at operation 404, the RAID component 113 selects a RAID scheme from a plurality of RAID schemes based on the RAID configuration information. At operation 406, the RAID component 113 receives, from a host system, a request to write a set of data. The RAID component 113, at operation 410, writes the set of data to the plurality of memory dies according to the selected RAID scheme.

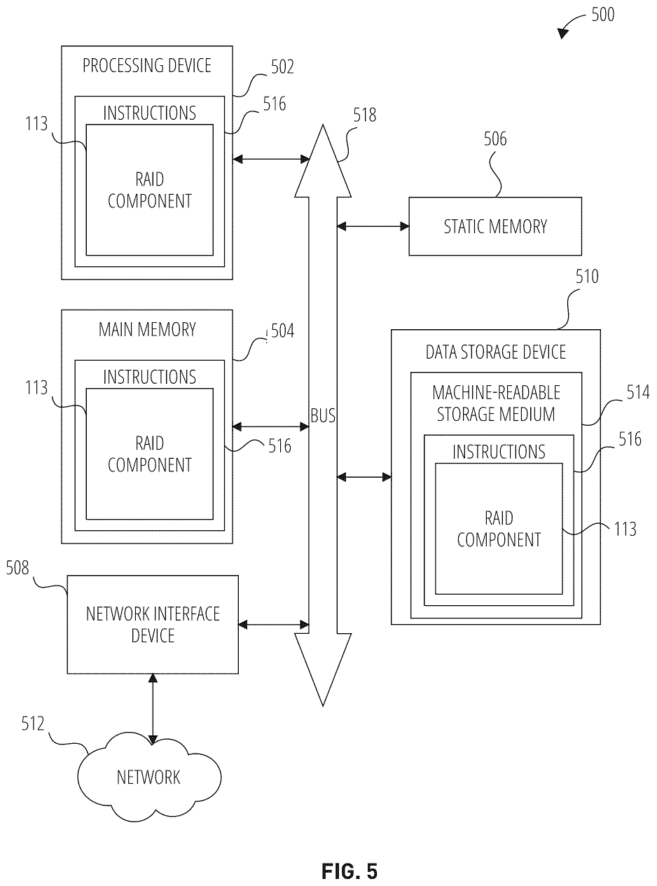

FIG. 5 illustrates an example machine in the form of a computer system 500 within which a set of instructions can be executed for causing the machine to perform any one or more of the methodologies discussed herein. In some examples, the computer system 500 can correspond to a host system (e.g., the host system 120 of FIG. 1) that includes, is coupled to, or uses a memory sub-system (e.g., the memory sub-system 110 of FIG. 1) or can be used to perform the operations described herein. In alternative examples, the machine can be connected (e.g., networked) to other machines in a local area network (LAN), an intranet, an extranet, and/or the Internet. The machine can operate in the capacity of a server or a client machine in a client-server network environment, as a peer machine in a peer-to-peer (or distributed) network environment, or as a server or a client machine in a cloud computing infrastructure or environment.

The machine can be a personal computer (PC), a tablet PC, a set-top box (STB), a Personal Digital Assistant (PDA), a cellular telephone, a web appliance, a server, a network router, a switch or bridge, or any machine capable of executing a set of instructions (sequential or otherwise) that specify actions to be taken by that machine. Further, while a single machine is illustrated, the term “machine” shall also be taken to include any collection of machines that individually or jointly execute a set (or multiple sets) of instructions to perform any one or more of the methodologies discussed herein.

The example computer system 500 includes a processing device 502, a main memory 504 (e.g., ROM, flash memory, DRAM such as SDRAM or Rambus DRAM (RDRAM), etc.), a static memory 506 (e.g., flash memory, static random access memory (SRAM), etc.), and a data storage device 510, which communicate with each other via a bus 518.

The processing device 502 represents one or more general-purpose processing devices such as a microprocessor, a central processing unit, or the like. More particularly, the processing device 502 can be a complex instruction set computing (CISC) microprocessor, a reduced instruction set computing (RISC) microprocessor, a very long instruction word (VLIW) microprocessor, a processor implementing other instruction sets, or processors implementing a combination of instruction sets. The processing device 502 can also be one or more special-purpose processing devices such as an application-specific integrated circuit (ASIC), a field programmable gate array (FPGA), a digital signal processor (DSP), a network processor, or the like. The processing device 502 is configured to execute instructions 516 for performing the operations and steps discussed herein. The computer system 500 can further include a network interface device 508 to communicate over a network 512.

The data storage device 510 can include a machine-readable storage medium 514 (also known as a computer-readable medium) on which is stored one or more sets of instructions 516 or software embodying any one or more of the methodologies or functions described herein. The instructions 516 can also reside, completely or at least partially, within the main memory 504 and/or within the processing device 502 during execution thereof by the computer system 500, the main memory 504 and the processing device 502 also constituting machine-readable storage media. The machine-readable storage medium 514, data storage device 510, and/or main memory 504 can correspond to the memory sub-system 110 of FIG. 1.

In one example, the instructions 516 include instructions to implement functionality corresponding to providing block failure protection for a zone memory sub-system as described herein (e.g., the RAID component 113 of FIG. 1). While the machine-readable storage medium 514 is shown in an example to be a single medium, the term “machine-readable storage medium” should be taken to include a single medium or multiple media that store the one or more sets of instructions. The term “machine-readable storage medium” shall also be taken to include any medium that is capable of storing or encoding a set of instructions for execution by the machine and that cause the machine to perform any one or more of the methodologies of the present disclosure. The term “machine-readable storage medium” shall accordingly be taken to include, but not be limited to, solid-state memories, optical media, and magnetic media.

Described implementations of the subject matter can include one or more features, alone or in combination as illustrated below by way of examples.

Example 1. A system comprising: a single stand-alone memory device comprising a plurality of memory dies; and a processing device, operatively coupled to the memory device, configured to perform operations comprising: accessing Redundant Array of Independent Disk (RAID) configuration information; selecting a RAID scheme from a plurality of RAID schemes based on the RAID configuration information; receiving, from a host system, a request to write a set of data; and writing the set of data to the plurality of memory dies according to the selected RAID scheme.

Example 2. The system of Example 1, wherein the plurality of RAID schemes comprises at least one of a RAID 0 scheme, a RAID 1 scheme, a RAID 5 scheme, or a RAID 10 scheme.

Example 3. The system of Example 2, wherein the selected RAID scheme comprises the RAID 0 scheme, the operations comprising: dividing the set of data into a plurality of data chunks; and writing a first data chunk of the plurality of data chunks on a first memory die of the plurality of memory dies; and writing a second data chunk of the plurality of data chunks on a second memory die of the plurality of memory dies.

Example 4. The system of any one of Examples 2-3, wherein the selected RAID scheme comprises the RAID 1 scheme, the operations comprising: writing a first copy of the set of data to a first memory die of the plurality of memory dies; and writing a second copy of the set of data to a second memory die of the plurality of memory dies.

Example 5. The system of Example 4, wherein the operations comprise: receiving a request to read the set of data from the host; and in response to receiving the request to read the set of data from the host, reading a first portion of the set of data from the first copy stored on the first memory die in parallel with reading a second portion of the set of data from the second copy stored on the second memory die.

Example 6. The system of any one of Examples 4-5, wherein the memory device comprises a first capacity reported to the host, wherein the first capacity reported to the host comprises half of an entire capacity of the memory device in response to determining that the selected RAID scheme comprises the RAID 1 scheme, the entire capacity being defined based on a total amount of available storage of the first memory die combined with a total amount of available stored on the second memory die.

Example 7. The system of any one of Examples 2-6, wherein the selected RAID scheme comprises the RAID 5 scheme, the operations comprising: dividing the set of data into a plurality of data chunks; generating set of parity data for each of the plurality of data chunks to enable recovery of a rest of the plurality of data chunks in case an individual one of the plurality of data chunks fails to be recovered; and writing a first data chunk of the plurality of data chunks along with a first portion of the set of parity data on a first memory die of the plurality of memory dies; and writing a second data chunk of the plurality of data chunks along with a second portion of the set of parity data on a second memory die of the plurality of memory dies, the first portion of the set of parity data being used to recover the second data chunk, and the second portion of the set of parity data being used to recover the first data chunk.

Example 8. The system of any one of Examples 2-7, wherein the selected RAID scheme comprises the RAID 10 scheme, wherein the plurality of memory dies comprises four memory dies, the operations comprising: dividing the set of data into a plurality of data chunks; and writing a first data chunk of the plurality of data chunks on a first memory die of the plurality of memory dies and on a second memory die of the plurality of memory dies; and writing a second data chunk of the plurality of data chunks on a third memory die of the plurality of memory dies and on a fourth memory die of the plurality of memory dies.

Example 9. The system of any one of Examples 1-8, the operations comprising:
managing storage of data according to the selected RAID scheme without involving the host system.
Example 10. The system of any one of Examples 1-9, wherein the selected RAID scheme enables the processing device to recover all data stored in a first memory die when the first memory die encounters an entire memory die failure.
Example 11. The system of any one of Examples 1-10, the operations comprising:
   receiving, from the host system, a command to select an individual RAID scheme; and storing the individual RAID scheme as part of the configuration information in response to receiving the command.
Example 12. The system of any one of Examples 1-11, wherein the memory device and the processing device are implemented as part of a single solid state drive (SSD).
Example 13. The system of Example 12, wherein the memory device comprises a three-dimensional (3D) NAND device.

Example 14. At least one non-transitory machine-readable storage medium comprising instructions that, when executed by a processing device, cause the processing device to perform operations comprising: accessing Redundant Array of Independent Disk (RAID) configuration information; selecting a RAID scheme from a plurality of RAID schemes based on the RAID configuration information; receiving, from a host system, a request to write a set of data; and writing the set of data to a plurality of memory dies of a single stand-alone memory device according to the selected RAID scheme.

Example 15. The non-transitory machine-readable storage medium of Example 14, wherein the plurality of RAID schemes comprises at least one of a RAID 0 scheme, a RAID 1 scheme, a RAID 5 scheme, or a RAID 10 scheme.

Example 16. The non-transitory machine-readable storage medium of any one of Examples 14-15, the operations comprising: managing storage of data according to the selected RAID scheme without involving the host system.

Example 17. The non-transitory machine-readable storage medium of any one of Examples 14-16, wherein the selected RAID scheme enables the processing device to recover all data stored in a first memory die when the first memory die encounters an entire memory die failure.

Example 18. A method comprising: accessing Redundant Array of Independent Disk (RAID) configuration information; selecting a RAID scheme from a plurality of RAID schemes based on the RAID configuration information; receiving, from a host system, a request to write a set of data; and writing the set of data to a plurality of memory dies of a single stand-alone memory device according to the selected RAID scheme.

Example 19. The method of Example 18, wherein the plurality of RAID schemes comprises at least one of a RAID 0 scheme, a RAID 1 scheme, a RAID 5 scheme, or a RAID 10 scheme.

Example 20. The method of any one of Examples 18-19, comprising: managing storage of data according to the selected RAID scheme without involving the host system.

The term “coupled with” generally refers to a connection between components, which can be an indirect communicative connection or direct communicative connection (e.g., without intervening components), whether wired or wireless, including connections such as electrical, optical, magnetic, and the like.

“System data” hereinafter refers to data that is created and/or maintained by the memory sub-system for performing operations in response to host requests and for media management.

“User data” hereinafter generally refers to host data and garbage collection data.

“RAID” refers to a process used in NAND flash memory to improve reliability and performance. It works by implementing redundancy and error correction at the chip level or memory device level. RAID distributes data across multiple NAND chips or memory dies within a single SSD or NAND storage system, storing redundant information to allow for data recovery in case of chip failures or errors. RAID employs advanced error correction algorithms to detect and correct errors at the chip or memory die level to enhance data integrity. By spreading data across multiple chips or memory dies, RAID can improve read and write speeds through parallel operations. If one NAND chip or memory die fails entirely (where all data stored by that die is invalidated or unrecoverable), the redundant data stored on other chips or memory dies can be used to reconstruct the lost information, reducing data loss risks. Additionally, RAID can help distribute write operations more evenly across NAND chips, potentially extending the overall lifespan of the SSD.

A “stand-alone single SSD” or stand-alone memory sub-system refers to a memory device comprising a self-contained solid-state drive that incorporates multiple non-volatile memory (NVM) dies within a single physical package. This SSD operates independently and does not require additional external SSDs to function. It includes its own controller and interface for communication with the host system. The stand-alone single SSD is capable of implementing various RAID (Redundant Array of Independent Disks) configurations internally across its multiple memory dies, without the need for separate physical drives or additional hardware.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. The present disclosure can refer to the action and processes of a computer system, or similar electronic computing device, that manipulates and transforms data represented as physical (electronic) quantities within the computer system's registers and memories into other data similarly represented as physical quantities within the computer system memories or registers or other such information storage systems.

The present disclosure also relates to an apparatus for performing the operations herein. This apparatus can be specially constructed for the intended purposes, or it can include a general purpose computer selectively activated or reconfigured by a computer program stored in the computer. Such a computer program can be stored in a computer-readable storage medium, such as, but not limited to, any type of disk including floppy disks, optical disks, CD-ROMs, and magnetic-optical disks, ROMs, RAMs, EPROMs, EEPROMs, magnetic or optical cards, or any type of media suitable for storing electronic instructions, each coupled to a computer system bus.

The algorithms and displays presented herein are not inherently related to any particular computer or other apparatus. Various general-purpose systems can be used with programs in accordance with the teachings herein, or it can prove convenient to construct a more specialized apparatus to perform the method. The structure for a variety of these systems will appear as set forth in the description below. In addition, the present disclosure is not described with reference to any particular programming language. It will be appreciated that a variety of programming languages can be used to implement the teachings of the disclosure as described herein.

The present disclosure can be provided as a computer program product, or software, that can include a machine-readable medium (such as a non-transitory machine-readable medium) having stored thereon instructions, which can be used to program a computer system (or other electronic devices) to perform a process according to the present disclosure. A machine-readable medium includes any mechanism for storing information in a form readable by a machine (e.g., a computer). In some examples, a machine-readable (e.g., computer-readable) medium includes a machine (e.g., a computer) readable storage medium such as a ROM, RAM, magnetic disk storage media, optical storage media, flash memory components, and so forth. A machine-readable storage medium can be non-transitory (in other words, not having any transitory signals) in that it does not embody a propagating signal. However, labeling a machine-readable storage medium “non-transitory” should not be construed to mean that the machine-readable storage medium is incapable of movement; the machine-readable storage medium should be considered as being transportable from one physical location to another.

In the foregoing specification, examples of the disclosure have been described with reference to specific examples thereof. It will be evident that various modifications can be made thereto without departing from the broader scope of examples of the disclosure as set forth in the following claims. The specification and drawings are, accordingly, to be regarded in an illustrative sense rather than a restrictive sense.

1. A system comprising:
a single stand-alone memory device comprising a plurality of memory dies; and
a processing device, operatively coupled to the memory device, configured to perform operations comprising:
accessing Redundant Array of Independent Disk (RAID) configuration information;
selecting a RAID scheme from a plurality of RAID schemes based on the RAID configuration information;
receiving, from a host system, a request to write a set of data; and
writing the set of data to the plurality of memory dies according to the selected RAID scheme.

2. The system of claim 1, wherein the plurality of RAID schemes comprises at least one of a RAID 0 scheme, a RAID 1 scheme, a RAID 5 scheme, or a RAID 10 scheme.

3. The system of claim 2, wherein the selected RAID scheme comprises the RAID 0 scheme, the operations comprising:
dividing the set of data into a plurality of data chunks; and
writing a first data chunk of the plurality of data chunks on a first memory die of the plurality of memory dies; and
writing a second data chunk of the plurality of data chunks on a second memory die of the plurality of memory dies.

4. The system of claim 2, wherein the selected RAID scheme comprises the RAID 1 scheme, the operations comprising:
writing a first copy of the set of data to a first memory die of the plurality of memory dies; and
writing a second copy of the set of data to a second memory die of the plurality of memory dies.

5. The system of claim 4, wherein the operations comprise:
receiving a request to read the set of data from the host; and
in response to receiving the request to read the set of data from the host, reading a first portion of the set of data from the first copy stored on the first memory die in parallel with reading a second portion of the set of data from the second copy stored on the second memory die.

6. The system of claim 4, wherein the memory device comprises a first capacity reported to the host, wherein the first capacity reported to the host comprises half of an entire capacity of the memory device in response to determining that the selected RAID scheme comprises the RAID 1 scheme, the entire capacity being defined based on a total amount of available storage of the first memory die combined with a total amount of available stored on the second memory die.

7. The system of claim 2, wherein the selected RAID scheme comprises the RAID 5 scheme, the operations comprising:
dividing the set of data into a plurality of data chunks;
generating set of parity data for each of the plurality of data chunks to enable recovery of a rest of the plurality of data chunks in case an individual one of the plurality of data chunks fails to be recovered; and
writing a first data chunk of the plurality of data chunks along with a first portion of the set of parity data on a first memory die of the plurality of memory dies; and
writing a second data chunk of the plurality of data chunks along with a second portion of the set of parity data on a second memory die of the plurality of memory dies, the first portion of the set of parity data being used to recover the second data chunk, and the second portion of the set of parity data being used to recover the first data chunk.

8. The system of claim 2, wherein the selected RAID scheme comprises the RAID 10 scheme, wherein the plurality of memory dies comprises four memory dies, the operations comprising:
dividing the set of data into a plurality of data chunks; and
writing a first data chunk of the plurality of data chunks on a first memory die of the plurality of memory dies and on a second memory die of the plurality of memory dies; and
writing a second data chunk of the plurality of data chunks on a third memory die of the plurality of memory dies and on a fourth memory die of the plurality of memory dies.

9. The system of claim 1, the operations comprising:
managing storage of data according to the selected RAID scheme without involving the host system.

10. The system of claim 1, wherein the selected RAID scheme enables the processing device to recover all data stored in a first memory die when the first memory die encounters an entire memory die failure.

11. The system of claim 1, the operations comprising:
receiving, from the host system, a command to select an individual RAID scheme; and
storing the individual RAID scheme as part of the configuration information in response to receiving the command.

12. The system of claim 1, wherein the memory device and the processing device are implemented as part of a single solid state drive (SSD).

13. The system of claim 12, wherein the memory device comprises a three-dimensional (3D) NAND device.

14. At least one non-transitory machine-readable storage medium comprising instructions that, when executed by a processing device, cause the processing device to perform operations comprising:
accessing Redundant Array of Independent Disk (RAID) configuration information;
selecting a RAID scheme from a plurality of RAID schemes based on the RAID configuration information;
receiving, from a host system, a request to write a set of data; and
writing the set of data to a plurality of memory dies of a single stand-alone memory device according to the selected RAID scheme.

15. The non-transitory machine-readable storage medium of claim 14, wherein the plurality of RAID schemes comprises at least one of a RAID 0 scheme, a RAID 1 scheme, a RAID 5 scheme, or a RAID 10 scheme.

16. The non-transitory machine-readable storage medium of claim 14, the operations comprising:
managing storage of data according to the selected RAID scheme without involving the host system.

17. The non-transitory machine-readable storage medium of claim 14, wherein the selected RAID scheme enables the processing device to recover all data stored in a first memory die when the first memory die encounters an entire memory die failure.

18. A method comprising:
accessing Redundant Array of Independent Disk (RAID) configuration information;
selecting a RAID scheme from a plurality of RAID schemes based on the RAID configuration information;
receiving, from a host system, a request to write a set of data; and
writing the set of data to a plurality of memory dies of a single stand-alone memory device according to the selected RAID scheme.

19. The method of claim 18, wherein the plurality of RAID schemes comprises at least one of a RAID 0 scheme, a RAID 1 scheme, a RAID 5 scheme, or a RAID 10 scheme.

20. The method of claim 18, comprising:
managing storage of data according to the selected RAID scheme without involving the host system.
